(19) United States
(12) Patent Application Publication
(10) Pub. No.: US 2026/0259095 A1
(43) Pub. Date: Sep. 3, 2026

(54) DIFFERENTIAL PRESSURE ASSEMBLY WITH PROTECTIVE BOOT AND ARRANGEMENT FOR AMPLIFYING POINTER

(71) Applicant: Watts Regulator Co., North Andover, MA (US)

(72) Inventors: Alfredo Marco CUCCINIELLO, Milano (IT); Francesco Guido ORNANO, Trento (IT); Giovanni Paolo COLOMBO, Triuggio (IT); Sergio FONTANA, Rovereto (IT)

(73) Assignee: Watts Regulator Co., North Andover, MA (US)

(21) Appl. No.: 19/163,089

(22) PCT Filed: Mar. 12, 2024
(86) PCT No.: PCT/US2024/019546

§ 371 Date: Sep. 8, 2025

Related U.S. Application Data
(60) Provisional application No. 63/490,157, filed on Mar. 14, 2023.

(51) Int. Cl. G01L 13/06; G01F 1/38; G01F 1/44; G01L 19/00; G01L 19/08

(52) U.S. Cl. CPC G01L 13/06; G01F 1/38; G01F 1/44; G01L 19/0007; G01L 19/08

(57) ABSTRACT

A differential pressure arrangement including an elongated tube having a proximal inlet and a distal inlet. A boot mounts in the elongated tube. The boot has an open proximal end aligned with the proximal inlet for receiving a primary flow. The boot also has a flexible intermediate bellows section in fluid communication with the open proximal end. The end of the boot is closed with a magnet coupled thereto. A spring, in the elongated tube, provides a bias force opposing the intermediate bellows section. The boot and spring are configured in balance so that variation between the primary flow and a secondary flow into the distal inlet moves the magnet as a function of the variation while the boot prevents mixing of the primary and secondary flow.

### CROSS-REFERENCE TO RELATED APPLICATIONS

This application is a U.S. National Stage Application under 35 U.S.C. 371 of co-pending International Application No. PCT/US24/19546 filed on Mar. 12, 2024, which claims priority to U.S. Provisional Patent Application No. 63/490,157 filed on Mar. 14, 2023, the contents of each are incorporated herein by reference in their entirety for any purpose whatsoever.

### FIELD OF THE DISCLOSURE

The subject disclosure relates to differential pressure assemblies such as found in balancing valves and differential pressure meters, and more particularly to differential pressure assemblies having a skinny protective boot that provides a bias force for positioning a magnet that moves in relation to pressure differences as well as an arrangement for amplifying movement of the pointer.

### BACKGROUND

Balancing valves are used to determine the flow rate of a fluid, e.g., water, in a system such as a heating system. Setting the flow rate is important because heating systems operate more efficiently when properly balanced. Differential pressure meters are used, for example, to determine pressure loss across an article in a fluid network.

Referring to FIG. 1, a schematic diagram of a prior art differential pressure meter 100 is shown. The meter 100 includes a chamber 102 having a sliding magnetic piston 104. The piston 104 is biased by a spring 106. As the piston 104 moves, a pointer 108 moves to provide a reading on a scale 110. As the fluid may include dirt and other sediment, it is undesirable to have the flow enter the piston 104. To isolate the piston 104 from the flow, a large, bulky diaphragm assembly 112 is utilized.

The diaphragm assembly 112 includes a large diameter housing 116 that increases the size and bulk of the meter 100. The housing 116 is necessary to mount a diaphragm 114 that acts as a barrier to prevent the flow from entering the piston 104. For another example, see US Patent Application Publication US2008/0289567A1 entitled METHOD AND APPARATUS FOR A GAUGE FOR INDICATING A PRESSURE OF A FLUID, published on Nov. 27, 2008, attached hereto. An example of a differential pressure gauge is shown in US Patent Application Publication US2020/0284674 entitled DIFFERENTIAL PRESSURE SENSOR WITH MAGNETIC DIAL, published on Sep. 10, 2020, attached hereto. An example of a balancing valve is shown in U.S. Pat. No. 10,247,590 entitled BALANCING VALVE FOR ADJUSTING THE DISTRIBUTION OF FLUIDS IN MULTIPLE PIPES, granted on Apr. 2, 2019, attached hereto.

### SUMMARY

In view of the above, a need exists for protecting the workings of the magnetic piston assembly of a system without creating undue bulk or complexity. The improved magnetic piston assembly would also preferably allow for full travel of the piston. A further need exists for an arrangement to amplify the movement of the pointer assembly to make easier and more accurate reading possible. The system may be a balancing valve, differential pressure meter, and the like.

The present disclosure is directed to a differential pressure system including an elongated tube having a proximal inlet and a distal inlet. A boot mounts in the elongated tube.

The boot has an open proximal end aligned with the proximal inlet for receiving a primary flow. The boot also has a flexible intermediate bellows section in fluid communication with the open proximal end. The end of the boot is closed with a magnet coupled thereto. A spring, in the elongated tube, provides a bias force opposing the intermediate bellows section. The boot and spring are configured in balance so that variation between the primary flow and a secondary flow into the distal inlet moves the magnet as a function of the variation while the boot prevents mixing of the primary and secondary flow.

Preferably, the differential pressure system also includes a head assembly having a face with indicia and a pointer assembly including a pointer magnetically coupled to the magnet so that the pointer assembly aligns with the indicia to provide a reading of differential pressure. The differential pressure system may have a body housing the tube, the body being configured to syphon a portion of the primary and second flow to the tube. If needed, a spring guide can be used to position the spring and may also couple to the closed distal end. Preferably, the magnet is enclosed in the closed distal end.

Still another embodiment of the present disclosure includes a differential pressure system including a tubular housing defining a chamber having a first and second pressure inlet. A protective boot is situated in the chamber between the first and second pressure inlet. The protective boot has a bellowed profile configured for extension and retraction in the chamber. The protective boot connects to the tubular housing at a proximal end and defines a magnet chamber at a distal end with a first magnet situated therein. A pointer assembly has an effort arm coupled to a magnet holder housing a second magnet. A load arm extends from the effort arm and has teeth engaging a pinion that couples to a pointer of a gauge. When the protective boot extends or retracts within the chamber based on a differential pressure between the first and second pressure inlet, the first magnet is driven axially. The first magnet is magnetically coupled with the second magnet to shift the effort arm and consequently the load arm of the pointer assembly, thereby moving the pointer of the gauge to indicate a differential pressure reading.

And yet another embodiment of the present disclosure includes a differential pressure system having a head assembly having a face with indicia. A body defines a primary inlet for receiving a primary flow and an outlet. The body has a tubular portion that defines a proximal end opening in fluid communication with the primary inlet and a distal end opening in fluid communication. The differential pressure system also has a check valve assembly positioned upstream of the primary inlet, the check valve assembly defining a Venturi aperture for expelling a secondary flow. An elongated boot mounts in the tubular portion. The elongated boot has a proximal open end for receiving the primary flow entering the proximal end opening as well as a closed distal end. A central passage extends from the open end to the closed distal end. A plurality of bellows surround the central passage. The system also has a distal magnet chamber adjacent the closed distal end with a magnet therein. In operation, the primary flow and the secondary flow act on the elongated boot so that the plurality of bellows extend and retract to, in turn, move the magnet axially in the tubular portion as a function of a differential pressure between the primary flow and the secondary flow. A pointer assembly includes a pointer that is magnetically coupled to the magnet so that the pointer aligns with the indicia to provide a reading of differential pressure.

Preferably, the elongated boot has a radially outward distal sealing surface. The differential pressure system may also include a spring guide coupled to the closed distal end and a spring against the spring guide to provide a counterforce to the bellows, wherein the boot protects the spring from the primary flow. In one embodiment, the elongated boot has a diameter sized substantially similar to a diameter of the tubular portion. The pointer assembly can include a second magnet magnetically coupled to the magnet for axial movement therewith, wherein the second magnet is outside the tubular portion as well as a sector gear coupled to the second magnet. The sector gear pivots about a fulcrum when the second magnet moves and includes a load arm having gear teeth. A pinion has a toothed hub that engages the gear teeth, wherein the pointer is coupled to the pinion for rotational movement therewith. In operation, the magnet moves the second magnet, which moves the sector gear about the fulcrum so that the load arm moves the hub and, in turn, the pointer to magnify movement of the magnet.

It should be appreciated that the subject technology can be implemented and utilized in numerous ways, including without limitation as a process, an apparatus, a system, a device, a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a schematic diagram of a prior art differential pressure system.

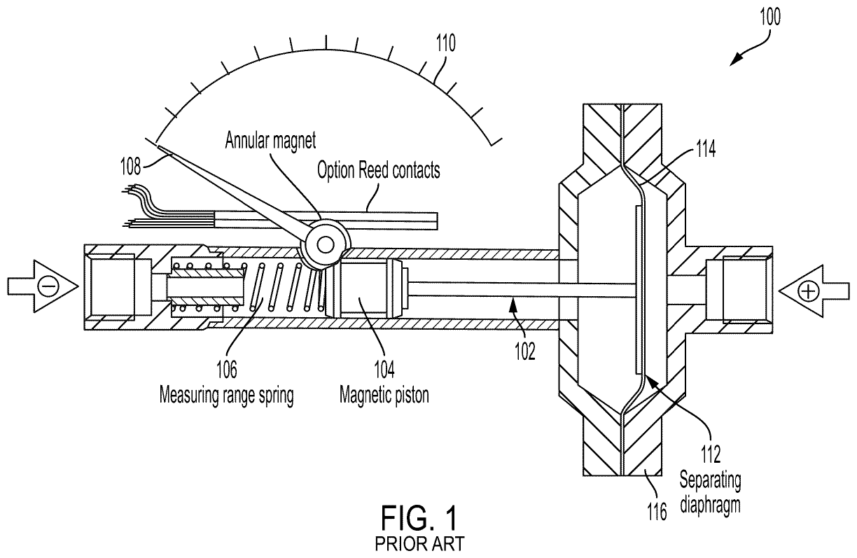

FIG. 2 is a perspective view of a differential pressure system in accordance with the subject disclosure.

FIG. 3 is a cross-sectional view of a differential pressure system in accordance with the subject disclosure.

FIG. 4 is another cross-sectional view of a differential pressure system in accordance with the subject disclosure.

FIG. 5 is a cross-sectional and partially cut-away view of a differential pressure system in accordance with the subject disclosure.

FIG. 6 is an exploded view of the piston assembly operationally positioned adjacent a pointer assembly of a differential pressure system in accordance with the subject disclosure.

FIG. 7 is a partially exploded view of the pointer assembly in isolation in accordance with the subject disclosure.

FIG. 8 is a relatively more exploded view of the pointer assembly in isolation in accordance with the subject disclosure.

FIG. 9 is a partially cross-sectional and exploded view of the piston assembly and the pointer assembly in isolation in a maximum reading position in accordance with the subject disclosure.

FIG. 10 is a partially cross-sectional and exploded view of the piston assembly and the pointer assembly in isolation in a minimum reading position in accordance with the subject disclosure.

### DETAILED DESCRIPTION

The subject technology overcomes many of the prior art problems associated with movable magnets in differential pressure systems and like technology such as balancing valves and differential pressure meters. The advantages, and other features of the technology disclosed herein, will become more readily apparent to those having ordinary skill in the art from the following detailed description of certain preferred embodiments taken in conjunction with the drawings which set forth representative embodiments of the present technology and wherein like reference numerals identify similar structural elements. Directional indications such as upward, downward, right, left and the like are used with respect to the figures and not meant in a limiting manner.

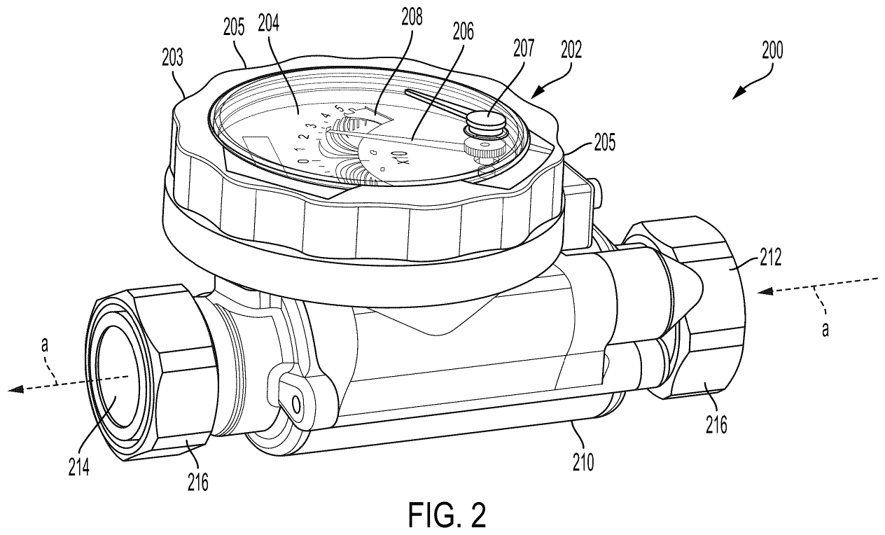

Referring now to the FIG. 2, there is shown a side, perspective view of a balancing valve 200 in accordance with the subject disclosure. The balancing valve 200 utilizes a differential pressure system in accordance with the subject technology but it is envisioned that a variety of valves, meters and the like can utilize the subject technology such as in a flow meter as well as a differential or absolute pressure meter. The balancing valve 200 includes a head assembly 202 having a face 204 and a pointer 206. The face 204 includes indicia 208 for reading the relative pressure. In the present example of FIG. 2, the indicia 208 ranges from −50 to +50 psi. Though, in other embodiments, the indicia 208 may be a different scale relative and appropriate to the application of the differential pressure balancing valve 200. A handwheel 203 surrounds the face 204. The handwheel 203 can be manually turned to open, to close or to an intermediate setting for the valve 200. Indicia 205 on the handwheel 203 indicate the opening and closing directions for the user. The user may also mark a setting of the valve 200 using a reference marker 207 rather than marking the head assembly 202 with ink as is traditionally done.

The head assembly 202 is coupled to a body 210 of the differential pressure balancing valve 200. The body 210 defines a first inlet 212 for receiving fluid or a primary flow, shown by flow arrow “a,” from a fluid network (not shown). The body 210 also has an outlet 214 for egress of the primary flow from the body 210. The body 210 is configured for installation into the fluid networks via installation couplings 216, each positioned respectively around the inlet 212 and outlet 214. The installation couplings 216 may be quick connect and disconnect configurations to easily insert and remove the differential pressure balancing valve 200 into the desired fluid network(s) for operation therein.

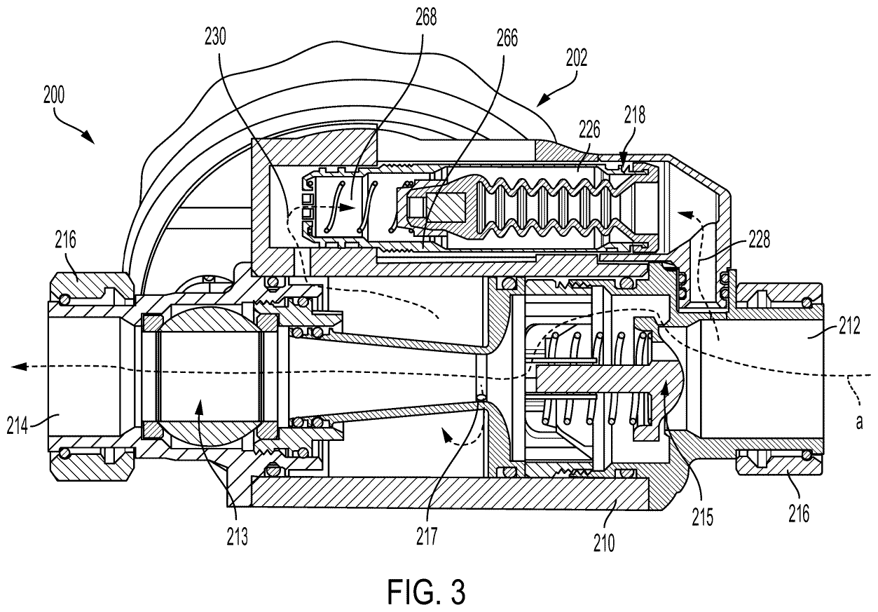

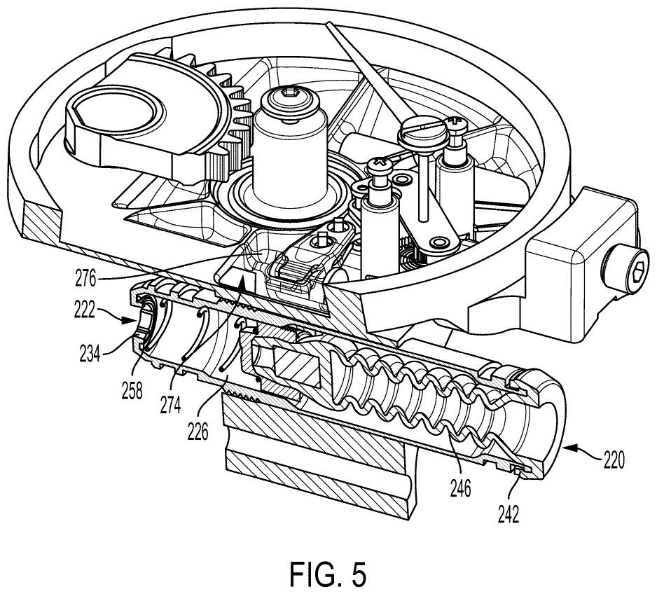

Referring now to FIGS. 3-5, cross-sectional views of the balancing valve 200 cut through the body 210 are shown to illustrate location of a piston assembly 218. The piston assembly 218 has opposing passages 220, 222 (see FIG. 5) for receiving and expelling the primary flow, respectively. The primary flow enters via the inlet 212 and mainly flows into a check valve assembly 215. The check valve assembly 215 includes a substantially cylindrical frame with an outer diameter such that the check valve assembly 215 may be coaxially inserted inside a chamber of the body 210. The cylindrical frame has a downstream opening, communicating with the inlet 212, and an upstream opening communicating with a cavity that simulates a Venturi device. The check valve assembly 215 houses internally a closing member displaceable in the longitudinal direction and having a head, designed to interfere so as to close/open the downstream opening of the check valve assembly 215, and a shank integral with the head.

The movement of the closing member in the longitudinal direction is preferably guided by a relief which is integral with the front downstream surface of the cylindrical frame of the check valve assembly 215 and inside which the shank slides.

A spring is coaxially arranged between the guiding relief and the head of the closing member and is calibrated to provide a suitable resistance to sliding of the closing member and therefore opening of the upstream aperture. In one embodiment, the cavity has a frustoconical shape with its greater base situated downstream.

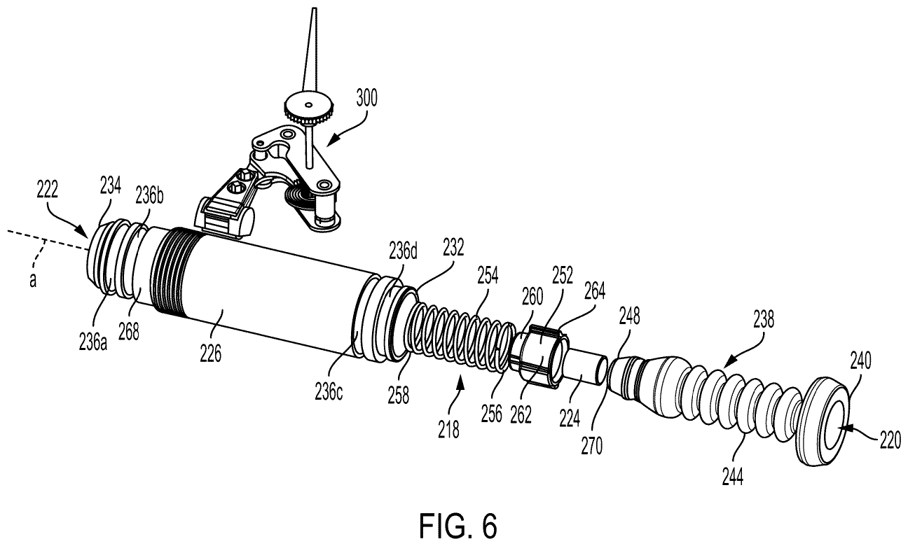

After the check valve 215, the primary flow substantially passes through a Venturi tube into a flow regulating valve 213 such as a ball valve. The Venturi tube defines a small Venturi aperture 217 to provide a portion of the flow into channel 230 and, thereby, into the tube 226. The tube 226, through the siphoning channel 230, scavenges a portion (e.g., a scavenged flow) of the primary flow from the inlet 212 of the body 210. The tube 226 also scavenges a portion of primary flow via channel 228. As a result, the piston assembly 218 receives opposing primary and secondary flows as described further below. Omitted from FIG. 5 is a portion of the body 210 of the differential pressure balancing valve 200, and portions of the head assembly 202 for ease of explanation of the inner workings of the differential pressure balancing valve 200. The head assembly 202 includes a pointer assembly 300 that is acted upon by the primary flow as described herein below. In short, the pointer assembly 300 is magnetically coupled to a sliding piston magnet 224 to create movement based upon variation in the primary flow referenced to the secondary flow. The magnet 224 slides linearly within the tube 226. Referring now to FIG. 6, an exploded view of the piston assembly 218 operationally positioned adjacent the pointer assembly 300 is shown. The tube 226 defines a proximal end opening 232 in fluid communication with the siphoning channel 228. Consequently, the proximal end opening 232 of the tube 226 is in fluid communication with the first inlet 212 of the body 210 for receiving scavenged flow from the primary flow. The tube 226 also defines a distal end opening 234 in fluid communication with the outlet.

The tube 226 includes several outer annular grooves 236a-d. The annular grooves 236a-c carry sealing o-rings (not shown). One annular groove 236d couples to an elongated protective boot 238. The protective boot 238 has a mouth 240 that surrounds the proximal end opening 232. The mouth 240 also includes an inner lip 242 that frictionally engages the annular groove 236d to retain the boot 238 in place. A diameter of the mouth 240 is substantially the same as or slightly larger than the diameter of the proximal end opening 232 of the tube 226. Thus, the protective boot 238 has a radially outward distal sealing surface to act as a sealing o-ring.

Referring additionally to FIG. 5, the protective boot 238 has a plurality of bellows 244 extending from the mouth 240 to form a central passage 246. The bellows 244 extend inwardly into the tube 226. The majority of the protective boot 238 is, in turn, situated within the tube 226. The bellows 244 have a distal closed end 248. When the mouth 240 of the protective boot 238 receives the primary flow, the primary flow travels a length of the central passage 246 of the boot 238 and remains therein, acting with pressure on the closed end 248 to longitudinally expand the bellows 244. Because the protective boot 238 is made of an elastomeric, rubber type material or a silicon type material, the bellows 244 can retract toward the proximal end opening 232, or can extend toward the distal end opening 234 of the tube 226 as pressure decreases and increases, respectively. In this regard, the protective boot 238 expands and retracts axially within the tube 226.

As best seen in FIG. 5, a distal closed end 248 of the protective boot 238 forms a magnet chamber 250 for housing the piston magnet 224. As best seen in FIG. 6, the piston magnet 224 is a cylinder, matching the distal magnet chamber 250 of the present example. Thus, the piston magnet 224 moves axially as the bellows 244 expand and retract based upon the pressure changes of the primary flow. The distal end 248 of the boot 238 has a beveled end 270 for form fitting a spring guide 252.

The spring guide 252 retains a first end 256 of a spring 254 that provides a counterbias force to that of the bellows 244. A second end 258 of the spring 254 is captured by an inner collar 258 of the tube 226. As such, the position of the piston magnet 224 is set by a balance between the opposing forces from the spring 254 acting against the force from the bellows 244. In another embodiment, the spring 254 has a complimentary shape to the bellows to be housed within the boot 238. As such, the spring 254 could be subject to the primary flow, whereas in the embodiment shown, the spring 254 is sealed and protected from the primary flow. In another embodiment, the spring 254 is configured to fit inside the bellows 2244, or by having a larger diameter may wrap around the bellows 244. Still further, the bellows 244 can even be overmolded onto the spring 254.

The extent to which the bellows 244 retract or extend is dependent on the differential pressure between the primary flow and the flow from the Venturi aperture 217 upstream of the check valve assembly 215, which passes into the distal end opening 222 of the tube 226, referred to hereinafter as the secondary flow. The secondary flow fills the tube 226 not filled by the boot. Thus, the pressure of the secondary flows acts to contract the bellows 244 to offset the pressure of the primary flow that acts to expand the bellows 244. The cumulative balance of the forces from the bellows 244, the spring 254, the primary flow, and secondary flow determine the ultimate position of the piston magnet 224. In other words, as the spring and bellows forces are static, the piston magnet 224 in the distal magnet chamber 250 changes position axially within the tube 226 as a function of the differential pressure between the primary flow and the secondary flow. Thus, the net force relative to the primary flow and secondary flow determines the position of the piston magnet.

For example, provided that the primary flow has a relative increase of pressure compared to the secondary flow, the pressure acting on the closed distal end 248 of the protective boot 238 will increase. In such an example, the protective boot 238 would extend toward the distal end opening 222 of the tube 226 so that the piston magnet 224 would move from right to left in FIGS. 3 and 5 relative to the previous position.

In contrast, provided that the primary flow has a relative pressure decrease, the pressure acting on the closed distal end 248 of the protective boot 238 reduces. In such an example, the protective boot 238 would retract toward the proximal end opening 232 of the tube 226 so that the piston magnet 224 would move from left to right in FIGS. 3 and 5 relative to the previous position.

In one application, the subject technology is used to determine pressure drop across an article. Consequently, the ball valve assembly 213 can be adjusted to manipulated desired output 214 flow rate. It is envisioned that the subject technology can be utilized in these and many other applications as would be appreciated by those of ordinary skill in the art after review of the subject disclosure.

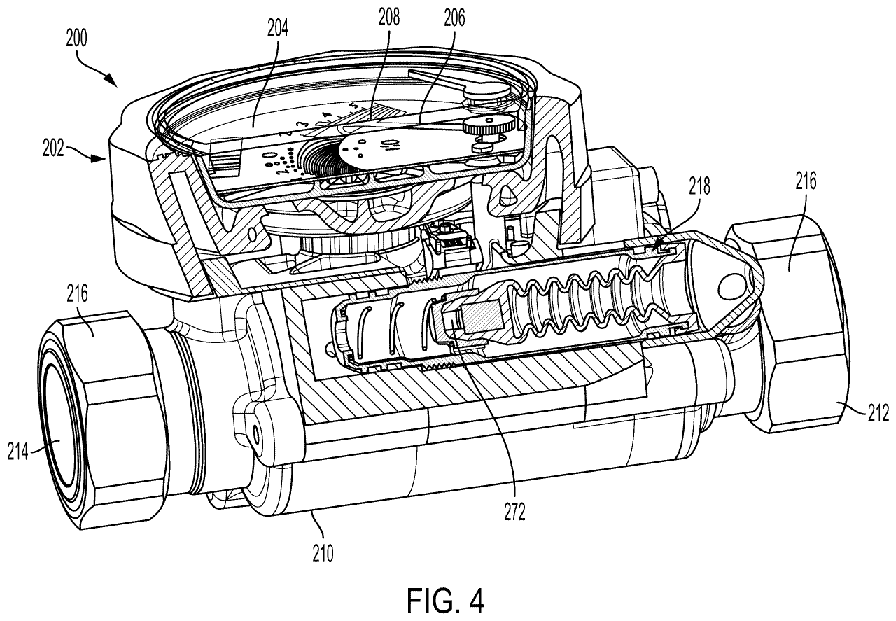

Still referring to FIGS. 3-6, the shaped spring guide 252 has narrower neck end 260 to insert within the spring 254, as best shown in FIG. 4, while a radially larger collar portion 262 prevents the spring guide 252 from sliding fully into the spring 254. The spring guide 252 has a plurality of radially outward struts 264 to minimize contact with the tube 226 to create an efficient sliding motion. As best seen in FIG. 3, the tube 226 has an intermediate tapered portion 266 so that the struts 264 move along the tapered portion 266. Thus, the bellows 244 are in a portion of the tube 226 with a relatively larger diameter. A distal portion 268 of the tube 226 has a still narrower diameter to effectively act as a hard stop for the spring guide in the distal direction (i.e., right to left as shown in the Figures).

The boot 238 narrows to distal beveled end 270 to form fit into the spring guide 252. Preferably, the distal end 270 is shaped to include a friction fit feature such as a flexible ridge so that the spring guide 252 can be effectively stuck on to the distal end 270. The distal end 270 also forms a necked opening 272 (best seen in FIGS. 3 and 4) so that the piston magnet 224 can be manually inserted into the magnet chamber 250 and snugly retained therein.

Alternatively, the boot 238 is over-molded on to the piston magnet 224 or the piston magnet 224 is fixedly secured in the magnet chamber 250 such as by adhesive.

Referring now to FIGS. 5-9, various views of the pointer assembly 300 are shown. The pointer assembly 300 includes several component parts, and for ease of explanation, the component parts are discussed individually. But, one having ordinary skill in the art will appreciate that some or all of the component parts may be integrally formed together. Without further ado, as best seen in FIG. 5, the head assembly 202 forms a compartment 274 for the pointer assembly 300. The pointer assembly 300 includes a frame assembly 330 and a pointer magnet assembly 310. The frame assembly 330 is fixed in place but the pointer magnet assembly 310 slides parallel to the axis “a”. Preferably, the compartment 274 includes sidewalls 276 that limit travel of the pointer magnet assembly 310.

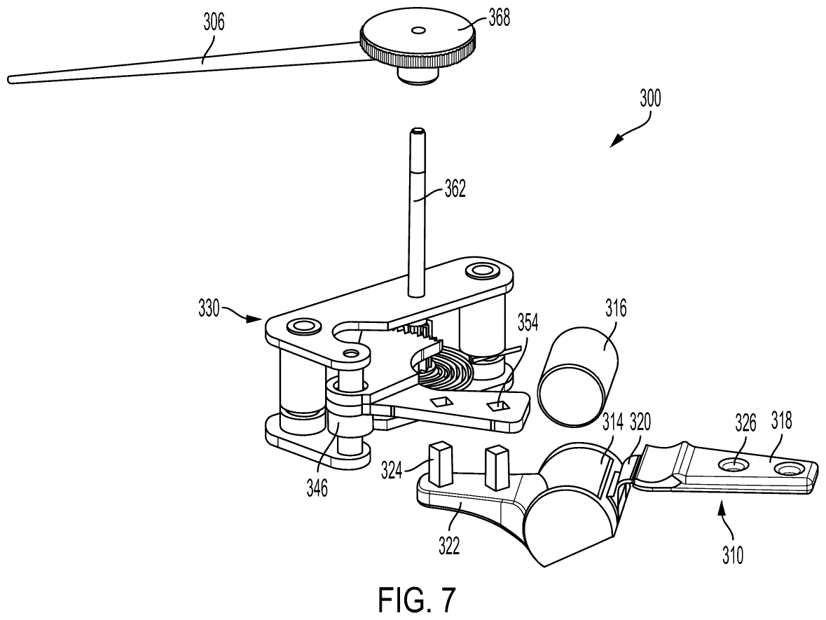

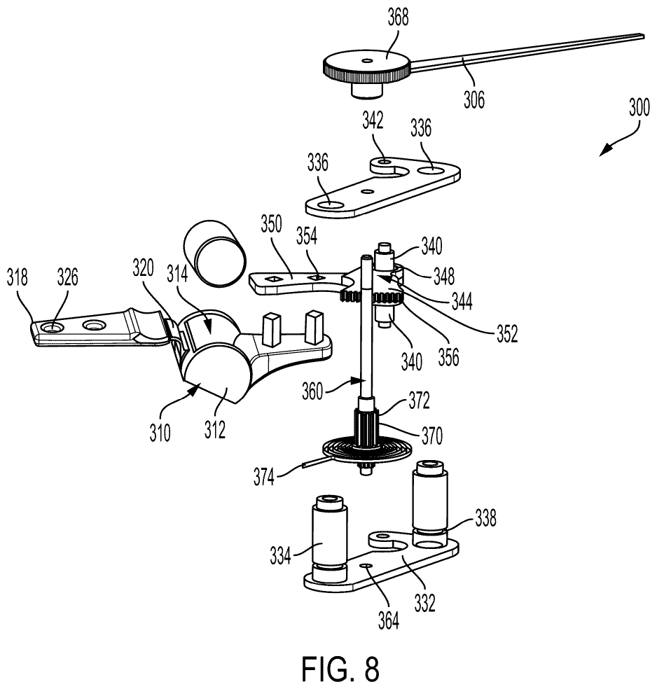

As best seen in FIGS. 6-8, the pointer magnet assembly 310 includes a holder 312 that forms a cavity 314 for housing a pointer magnet 316. The holder 312 is shown closed in FIG. 6 and open in FIGS. 7 and 8. The pointer magnet 316 is complimentary in shape to the cavity 314 for snugly nesting therein. The holder 312 includes a cap 318 connected by a hinge 320 to rotate to enclose the pointer magnet 316 in the cavity 314. The cap 318 matches an extension 322 branching from the cavity 314 so that two square pegs 324 can pass through openings 326 in the cap 318. To close the pointer magnet 316 in the cavity 314, the cap 318 swings around so that the cap 318 and extension 322 are substantially aligned and the two square pegs 324 extend through the openings 326.

The frame assembly 330 includes upper and lower plates 332 that are somewhat L-shaped. The plates 332 are separated and connected by two standoffs 334 configured to insert into mounting holes 336 at the top and corner of the L-shape. The standoffs 334 may be secured to the plates 332 by adhesive, fasteners and the like such as rivets and screws. The standoffs 334 include a lower annular groove 338. Preferably, the plates 332 are identical and interchangeable and, similarly, the standoffs 334 are identical and interchangeable.

An anchor fulcrum 340 similarly extends between the plates 332 and couples into mounting holes 342 formed in the plates 332 at a short end of the L-shape. The anchor fulcrum 340 is also fixed to the plates 332 similarly to the standoffs 334. As such, the anchor fulcrum 340 may also serve to support and fix the plates 332 in position. The anchor fulcrum 340 rotatably supports a sector gear 344 by having an intermediate bushing 346. The sector gear 344 has a central aperture 348 so that the sector gear 344 can slide on to the anchor fulcrum 340 and rest on the bushing 346.

The sector gear 344 includes an effort arm 350 and a load arm 352 so that the sector gear 344 can act as a lever. The effort arm 350 and the load arm 352 may be integrally formed or be separate part joined together. The effort arm 350 and the load arm 352 have a fixed relationship so that rotation around the anchor fulcrum 340 by the effort arm 350 leads to corresponding, and optionally displaced, rotation around the anchor fulcrum 340 by the load arm 352. For example, depending upon sizing, clockwise rotation around the anchor fulcrum 340 by the effort arm 350 by 45 degrees leads to corresponding clockwise rotation around the anchor fulcrum 340 of more than 45 degrees by the load arm 352. The resulting effect is amplification of motion. In another embodiment, the clockwise rotation around the anchor fulcrum 340 by the effort arm 350 by 45 degrees leads to corresponding clockwise rotation around the anchor fulcrum 340 of 45 degrees by the load arm 352.

In another embodiment, the central aperture 348 is keyed to the anchor fulcrum 340 so that the anchor fulcrum 340 rotates therewith. The effort arm 350 forms two bores 354 for operably receiving the two square pegs 324 of the pointer magnet assembly 310. The load arm 352 terminates in a rack of gear teeth 356. The load arm 352 and the effort arm 350 may be displaced from each other forming an L-shape, U-shape, or the like.

The support frame assembly 330 also rotatably supports a pinion assembly 360 that interacts with the gear teeth 356 to set the position of the pinion assembly 360. The pinion assembly 360 includes a central post 362 that rotatably mounts in a bore 364 of the lower plate 332. The central post 362 also extends through the bore 364 in the upper plate 332 to couple to the pointer 306. Thus, when the central post 362 rotates, so does the pointer 306. The pointer assembly 300 includes a hub 368 for coupling to the central post 362 and the pointer 306.

The central post 362 is able to rotate in the bores 364. As such, a diameter of the central post 362 is equal to or less that a diameter of the bores 364. A hair spring 374 couples to the central post 362 and extends to the lower annular groove 338 of one of the standoffs 334. As such, the hair spring 374 eliminates hysteresis error that may be generated by the section gear 344 and pinion assembly 360 and/or any weight of the pointer assembly 300.

Toward a lower end of the central post 362, in the vicinity of where the central post 362 enters the bore 364 defined by the lower plate 332, the pinion assembly 360 has a pinion 370 with a set of radial teeth 372, fully or partially circumferentially disposed around the central post 362. The pinion teeth 372 engage the sector gear teeth 356 of the load arm 352. As such, upon rotation of the load arm 352 around the anchor fulcrum 340, and by nature of the relationship with the effort arm 350, rotation of the effort arm 350 around the anchor fulcrum 340, the sector gear teeth 356 shift position and rotate the pinion 370 due to the contact between the sector gear teeth 356 and the radial teeth 372 of the pinion 370.

For example, if the effort arm 350 shifts clockwise around the anchor fulcrum 340, the load arm 352 in turn will shift clockwise around the anchor fulcrum 340. This movement shifts the sector gear teeth 356 correlatively and thus rotates the radial teeth 372 of the pinion 370 inversely counterclockwise and turns the pinion assembly 360. As mentioned above, the square pegs 324 of the pointer magnet assembly 310 engage the two bores 354 of the effort arm 350. Thus, the holder assembly 310 is fixedly coupled to the section gear 344.

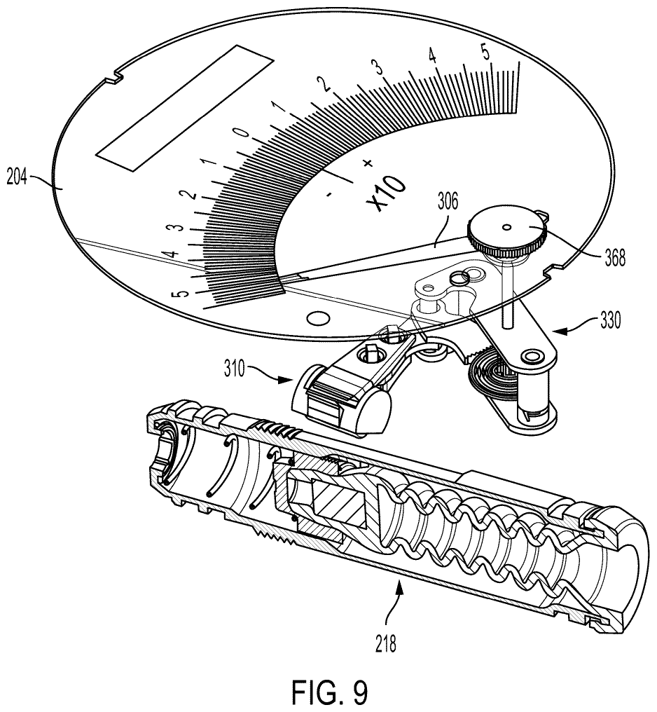

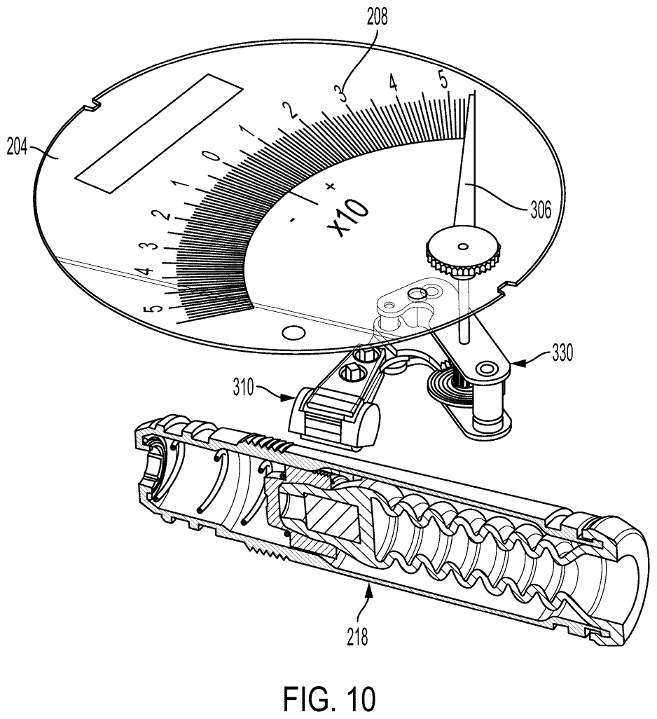

Referring now to FIGS. 9 and 10, partially cross-sectional, exploded views of the piston assembly 218 and the pointer assembly 300 in isolation in maximum and minimum reading positions are shown. The differential pressure balancing valve 200 is assembled and aligned such that the piston magnet 224 and the pointer magnet 316 are in close proximity to be magnetically coupled. In other words, as the pressure differential between the primary flow and the secondary flow varies to extend and retract the bellows 244, the piston magnet 224 moves linearly along axis “a” and, even without touching, the pointer magnet 316 moves similarly parallel to axis “a”.

As the pointer magnet 316 is pulled by the piston magnet 224, the holder assembly 310 similarly moves. Because the pointer magnet 316 is chambered in the holder assembly 310, the square pegs 324 shift the effort arm 350 to rotate around the anchor fulcrum 340. The effort arm 350 leverages the load arm 352 and consequently the sector gear teeth 356 turn the pinion 370. The pointer 206 rotates with the pinion 370 to provide a reading on the indicia 208. Under static conditions (e.g., the difference between the primary and secondary flows is steady), nothing moves and the pointer 206 maintains a consistent reading.

For example, when the primary flow in the protective boot 238 has a lessening pressure compared to the secondary flow in the tube 226, the pressure acting on the bellows 244 will cause the protective boot 238 to retract toward the proximal end opening 234 of the tube 226. As a result, the piston magnet 224 shifts axially along the axis “a” pulling the pointer magnet 316 and thus the holder assembly 310 in the same direction.

The square pegs 324 of the holder assembly 310 shift the effort arm 350 counterclockwise with reference to FIG. 10 and the load arm 352 moves similarly. Consequently, the sector gear teeth 356 turn the pinion 370 clockwise, which rotates the pointer 206 clockwise as well. As can be seen in FIG. 10, the pointer 206 represents a positive reading on the indicia 208. In the opposite scenario of the balance having the difference between the primary and secondary flow increasing, the bellows 244 extend along axis “a” and the remaining movements are in the opposite direction, which would move the needed from, for example, a maximum as shown in FIG. 10 to the minimum reading of FIG. 9.

In another embodiment, the spring guide carries the piston magnet. Several other components may be rearranged, combined and/or separated. For example, the magnet holder 314 may simply be overmolded on to the pointer magnet 316. The load arm 352 and the effort arm 350 may be integrally formed with each other. The sector gear 344, magnet holder 314, and pointer magnet 316 may also be a single integrally formed part such as by over-molding. The pointer magnet 316 may also be simply externally mounted as well.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., fasteners, couplings, valves, seals, o-rings, components and the like) shown as distinct or even omitted for purposes of illustration may be incorporated within other functional elements in a particular implementation. For brevity, discussion of such components are not described herein.

Further, although the subject technology has been described with respect to the field of differential pressure meters, it is envisioned that the subject technology would be equally applicable to other fields and applications such as pressure and flow measurement where prophylactic protection and/or amplified movement is magnetically coupled elements is desirable.

All patents, patent applications and other references disclosed herein are hereby expressly incorporated in their entireties by reference. While the subject technology has been described with respect to preferred embodiments, those skilled in the art will readily appreciate that various changes and/or modifications can be made to the subject technology without departing from the spirit or scope of the invention as defined by the appended claims. For example, each claim may depend from any or all claims in a multiple dependent manner even though such has not been originally claimed.

What is claimed is:

1. A differential pressure arrangement comprising:
a head assembly having a face with indicia;
a body defining a main passage from a primary inlet for receiving a primary flow to an outlet, the body having a tubular portion parallel the main passage that defines: a proximal end opening in fluid communication with the primary flow; and a distal end opening, wherein the body defines a channel to create a first scavenged portion of the primary flow;
a check valve assembly positioned upstream of the primary inlet, the check valve assembly coupled to a Venturi tube for expelling a secondary flow in communication with the outlet, wherein the Venturi tube defines a hole in fluid communication with the distal end opening for providing a second scavenged portion of the primary flow to the distal end opening;
an elongated boot in the tubular portion, the elongated boot defining: a proximal open end for receiving the first scavenged portion of the primary flow entering the proximal end opening; a closed distal end; a central passage extending from the open end to the closed distal end, wherein the boot has a plurality of bellows forming a portion of the central passage; and a distal magnet chamber adjacent the closed distal end;
a magnet in the distal magnet chamber, wherein in operation, the first and second scavenged portions of the primary flow and the secondary flow act on the elongated boot so that the plurality of bellows extend and retract to, in turn, move the magnet axially in the tubular portion as a function of a differential pressure between the primary flow and the secondary flow; and
a pointer assembly including a pointer and magnetically coupled to the magnet so that the pointer aligns with the indicia to provide a reading of differential pressure.

2. The differential pressure arrangement of claim 1, wherein the elongated boot has a radially outward distal sealing surface.

3. The differential pressure arrangement of claim 1, further comprising: a spring guide coupled to the closed distal end; and a spring against the spring guide to provide a counterforce to the bellows, wherein the boot protects the spring from the primary flow.

4. The differential pressure arrangement of claim 1, wherein the elongated boot has a diameter sized substantially similar to a diameter of the tubular portion.

5. The differential pressure arrangement of claim 1, wherein the pointer assembly includes:
a second magnet magnetically coupled to the magnet for axial movement therewith, wherein the second magnet is outside the tubular portion;
a sector gear coupled to the second magnet, wherein the sector gear: pivots about a fulcrum when the second magnet moves; and includes a load arm having gear teeth; and
a pinion having a toothed hub that engages the gear teeth, wherein the pointer is coupled to the pinion for rotational movement therewith,
wherein in operation, the magnet moves the second magnet, which moves the sector gear about the fulcrum so that the load arm moves the hub and, in turn, the pointer to magnify movement of the magnet.

6. The differential pressure arrangement of claim 1, wherein the reading relates to a flow setting of the arrangement.

7. The differential pressure arrangement of claim 1, wherein the reading relates to a differential pressure between the primary flow and the secondary flow.

8. The differential pressure arrangement of claim 1, further comprising a ball valve assembly upstream of the check valve assembly, the ball valve assembly configurable based on the reading.

9. A differential pressure meter comprising:
an elongated tube having a proximal inlet and a distal inlet;
a boot in the elongated tube, the boot having: an open proximal end aligned with the proximal inlet for receiving a primary flow; an intermediate bellows section in fluid communication with the open proximal end; and a closed distal end;
a magnet coupled to the closed distal end; and
a spring in the elongated tube for providing a bias force opposing the intermediate bellows section,
wherein the boot and spring are configured in balance so that variation between the primary flow and a secondary flow into the distal inlet moves the magnet as a function of the variation while the boot prevents mixing of the primary and secondary flow.

10. The differential pressure meter of claim 9, further comprising: a head assembly having a face with indicia; and a pointer assembly including a pointer magnetically coupled to the magnet so that the pointer assembly aligns with the indicia to provide a reading of differential pressure.

11. The differential pressure meter of claim 9, further comprising a body housing the tube, the body being configured to syphon a portion of the primary and second flow to the tube.

12. The differential pressure meter of claim 9, further comprising a spring guide coupled to the spring and closed distal end.

13. The differential pressure meter of claim 9, wherein the magnet is enclosed in the closed distal end.

14. A differential pressure meter comprising:
a tubular housing defining a chamber having a first and second pressure inlet;
a protective boot situated in the chamber between the first and second pressure inlet, the protective boot having a bellowed profile configured for extension and retraction in the chamber, the protective boot connecting to the tubular housing at a proximal end, the protective boot defining a magnet chamber at a distal end;
a first magnet situated in the magnet chamber of the protective boot; and
a pointer assembly having an effort arm and a load arm, the effort arm coupled to a magnet holder housing a second magnet, the load arm engaging teeth of a pinion, the pinion coupling to a pointer of a gauge,
wherein:
the protective boot extends or retracts within the chamber based on a differential pressure between the first and second pressure inlet, driving the first magnet axially, and
the first magnet is configured to interact with the second magnet to shift the effort arm and consequently the load arm of the pointer assembly, thereby moving the pointer of the gauge.
